(19) United States
(12) Patent Application Publication
(10) Pub. No.: US 2007/0146240 A1
(43) Pub. Date: Jun. 28, 2007

(54) Plasma display apparatus

(75) Inventor: Seonghak Moon, Seoul (KR)

Correspondence Address: KED & ASSOCIATES, LLP, P.O. Box 221200, Chantilly, VA, 20153-1200, US

(73) Assignee: LG Electronics Inc.

(21) Appl. No.: 11/642,852

(22) Filed: Dec. 21, 2006

(30) Foreign Application Priority Data
Dec. 23, 2005 (KR) 10-2005-0128865

(51) Int. Cl. G09G 3/28

(52) U.S. Cl. 345/68

(57) ABSTRACT

A plasma display apparatus is disclosed. The plasma display apparatus includes a plasma display panel including a scan electrode and a sustain electrode, and a scan driver. The scan driver supplies a first set-down voltage of a set-down pulse during a reset period, a scan voltage of a scan pulse during an address period, and a negative sustain voltage of a sustain pulse of a negative polarity during a sustain period to the scan electrode using a first voltage source.

This Nonprovisional application claims priority under 35 U.S.C. §119(a) on Patent Application No. 10-2005-0128865 filed in Korea on Dec. 23, 2005 the entire contents of which are hereby incorporated by reference.

### BACKGROUND

1. Field

This document relates to a display apparatus, and more particularly, to a plasma display apparatus.

2. Description of the Related Art

Out of display apparatuses, a plasma display apparatus comprises a plasma display panel and a driver for driving the plasma display panel.

The plasma display panel has the structure in which barrier ribs formed between a front panel and a rear panel forms unit discharge cell or discharge cells. Each discharge cell is filled with an inert gas containing a main discharge gas such as neon (Ne), helium (He) and a mixture of Ne and He, and a small amount of xenon (Xe).

The plurality of discharge cells form one pixel. For example, a red (R) discharge cell, a green (G) discharge cell, and a blue (B) discharge cell form one pixel.

When the plasma display panel is discharged by a high frequency voltage, the inert gas generates vacuum ultraviolet rays, which thereby cause phosphors formed between the barrier ribs to emit light, thus displaying an image. Since the plasma display panel can be manufactured to be thin and light, it has attracted attention as a next generation display device.

The related art plasma display apparatus supplies a reset pulse having both a positive voltage and a negative voltage during a reset period. Therefore, the related art plasma display apparatus had to use a switch or a separate switch with a high-level withstanding voltage characteristic so as to control a difference between the positive voltage and the negative voltage.

Further, since the related art plasma display apparatus separately includes a circuit for supplying a voltage during the reset period and an address period and a circuit for supplying a voltage during a sustain period, the manufacturing cost of the related art plasma display apparatus increases.

### SUMMARY

In one aspect, a plasma display apparatus comprises a plasma display panel including a scan electrode and a sustain electrode, and a scan driver that supplies a first set-down voltage of a set-down pulse during a reset period, a scan voltage of a scan pulse during an address period, and a negative sustain voltage of a sustain pulse of a negative polarity during a sustain period to the scan electrode, wherein the first set-down voltage, the scan voltage, and the negative sustain voltage are supplied using a first voltage source.

A voltage level of the first voltage source may be equal to the negative sustain voltage.

The scan driver may include a scan/sustain voltage supply controller, connected to the first voltage source, controlling the supplying of the scan voltage and the negative sustain voltage to the scan electrode, and a first set-down voltage supply controller, connected in parallel to the scan/sustain voltage supply controller, controlling the supplying of the first set-down voltage to the scan electrode.

The scan driver may include a scan reference voltage supply controller controlling the supplying of a scan reference voltage to the scan electrode during the address period, and a first ground level voltage supply controller controlling the supplying of a ground level voltage of the sustain pulse to the scan electrode during the sustain period.

The scan reference voltage may be equal to a negative voltage level.

The plasma display apparatus further comprises a sustain driver that supplies a second set-down voltage during the reset period, and a sustain pulse having a ground level voltage and the negative sustain voltage during the sustain period to the sustain electrode.

In another aspect, a plasma display apparatus comprises a plasma display panel including a scan electrode and a sustain electrode, and a scan driver that supplies a first set-down voltage of a set-down pulse during a reset period and a negative sustain voltage of a sustain pulse of a negative polarity during a sustain period to the scan electrode using a first voltage source, and supplies a scan voltage of a scan pulse to the scan electrode during an address period using a second voltage source.

A voltage level of the first voltage source may be equal to the negative sustain voltage, and the voltage level of the first voltage source may be lower than a voltage level of the second voltage source.

The scan driver may include a sustain voltage supply controller, connected to the first voltage source, controlling the supplying of the negative sustain voltage to the scan electrode, a first set-down voltage supply controller, connected in parallel to the sustain voltage supply controller, controlling the supplying of the first set-down voltage to the scan electrode, and a scan voltage supply controller, connected to the second voltage source, controlling the supplying of the scan voltage to the scan electrode.

The scan driver may include a scan reference voltage supply controller controlling the supplying of a scan reference voltage to the scan electrode during the address period, and a first ground level voltage supply controller controlling the supplying of a ground level voltage of the sustain pulse to the scan electrode during the sustain period.

The scan reference voltage may be equal to a negative voltage level.

The scan driver may include a first ground level voltage supply controller that controls the supplying of a ground level voltage of the sustain pulse to the scan electrode during the sustain period and the supplying of a scan reference voltage to the scan electrode during the address period, wherein the ground level voltage of the sustain pulse and the scan reference voltage may be supplied using a ground level voltage source.

The plasma display apparatus further comprises a sustain driver that supplies a second set-down voltage during the reset period, and a sustain pulse having a ground level voltage and the negative sustain voltage during the sustain period to the sustain electrode.

In still another aspect, a plasma display apparatus comprises a plasma display panel including a scan electrode and a sustain electrode, a scan driver that supplies a first set-down voltage of a set-down pulse during a reset period and a scan voltage of a scan pulse during an address period to the scan electrode using a first voltage source, and supplies a negative sustain voltage of a sustain pulse of a negative polarity to the scan electrode during a sustain period using a second voltage source, and a sustain driver that supplies a second set-down voltage during the reset period, and a sustain pulse having a ground level voltage and the negative sustain voltage during the sustain period to the sustain electrode.

A voltage level of the second voltage source may be equal to the negative sustain voltage, and the voltage level of the second voltage source may be lower than a voltage level of the first voltage source.

The scan driver may include a scan voltage supply controller, connected to the first voltage source, controlling the supplying of the scan voltage to the scan electrode, a first set-down voltage supply controller, connected in parallel to the scan voltage supply controller, controlling the supplying of the first set-down voltage to the scan electrode, and a sustain voltage supply controller, connected to the second voltage source, controlling the supplying of the negative sustain voltage to the scan electrode.

The scan driver may include a scan reference voltage supply controller controlling the supplying of a scan reference voltage to the scan electrode during the address period, and a first ground level voltage supply controller controlling the supplying of a ground level voltage of the sustain pulse to the scan electrode during the sustain period.

The scan reference voltage may be equal to a negative voltage level.

The scan driver may include a first ground level voltage supply controller that controls the supplying of a ground level voltage of the sustain pulse to the scan electrode during the sustain period and the supplying of a scan reference voltage to the scan electrode during the address period, wherein the ground level voltage of the sustain pulse and the scan reference voltage may be supplied using a ground level voltage source.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention.

FIG. 1 illustrates a plasma display apparatus according to embodiments;

FIG. 2 illustrates one example of the structure of a plasma display panel of the plasma display apparatus according to the embodiments;

FIG. 3 illustrates a plasma display apparatus according to a first embodiment;

FIG. 4 illustrates a driving waveform generated by the plasma display apparatus according to the first embodiment;

FIG. 5 illustrates a plasma display apparatus according to a second embodiment;

FIG. 6 illustrates a driving waveform generated by the plasma display apparatus according to the second embodiment;

FIG. 7 illustrates a plasma display apparatus according to a third embodiment;

FIG. 8 illustrates a driving waveform generated by the plasma display apparatus according to the third embodiment;

FIG. 9 illustrates a plasma display apparatus according to a fourth embodiment;

FIG. 10 illustrates a driving waveform generated by the plasma display apparatus according to the fourth embodiment;

FIG. 11 illustrates a plasma display apparatus according to a fifth embodiment; and

FIG. 12 illustrates a driving waveform generated by the plasma display apparatus according to the fifth embodiment.

### DETAILED DESCRIPTION OF PREFERRED EMBODIMENTS

Reference will now be made in detail embodiments of the invention examples of which are illustrated in the accompanying drawings.

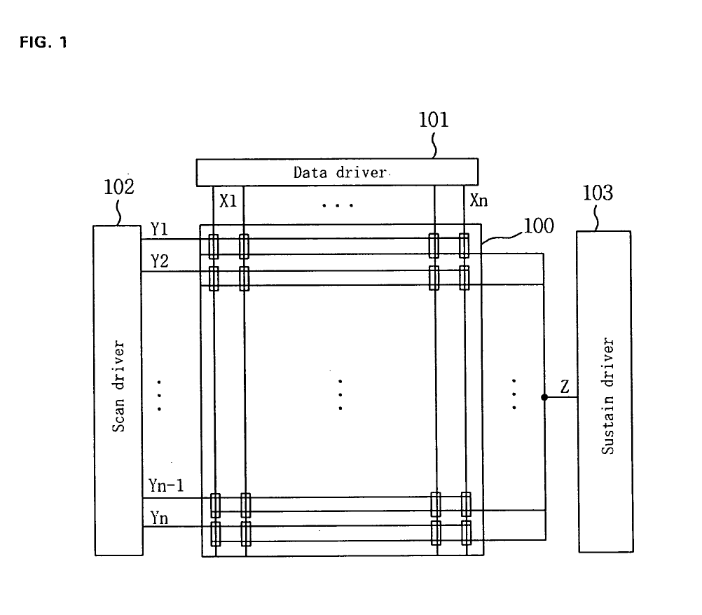

FIG. 1 illustrates a plasma display apparatus according to embodiments.

Referring to FIG. 1, the plasma display apparatus according to the embodiments includes a plasma display panel 100 and a driver for supplying a predetermined driving voltage to electrodes of the plasma display panel 100. The driver includes a data driver 101, a scan driver 102, and a sustain driver 103.

The scan driver 102 and the sustain driver 103 may correspond to a first driver. The data driver 101 may correspond to a second driver.

The plasma display panel 100 includes a front panel (not illustrated) and a rear panel (not illustrated) which are coalesced at a given distance therebetween, and a plurality of electrodes. The plurality of electrodes includes scan electrode Yl to Yn, sustain electrodes Y, and address electrodes Xl to Xn.

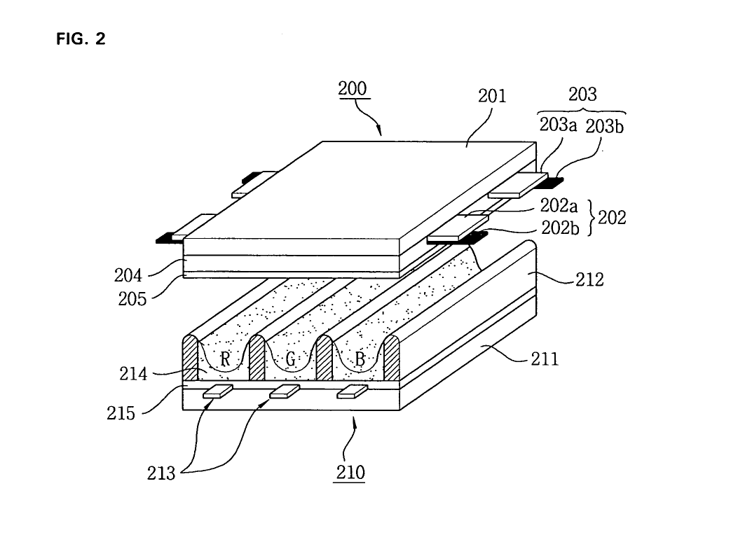

The following is a detailed description of the structure of the plasma display panel 100 with reference to FIG. 2.

As illustrated in FIG. 2, the plasma display panel 100 of the plasma display apparatus according to the embodiments includes a front panel 200 and a rear panel 210 which are coupled in parallel to oppose to each other at a given distance therebetween. The front panel 200 includes a front substrate 201 being a display surface on which an image is displayed. The rear panel 210 includes a rear substrate 211 constituting a rear surface. A plurality of scan electrodes 202 and a plurality of sustain electrodes 203 are formed on the front substrate 201. A plurality of address electrodes 213 are arranged on the rear substrate 211 to intersect the scan electrodes 202 and the sustain electrodes 203.

The scan electrode 202 and the sustain electrode 203 each includes transparent electrodes 202a and 203a made of transparent indium-tin-oxide (ITO) material, and bus electrodes 202b and 203b made of a metal material. The scan electrode 202 and the sustain electrode 203 generate a mutual discharge therebetween in one discharge cell, and maintain light-emissions of the discharge cells.

The scan electrode 202 and the sustain electrode 203 are covered with one or more upper dielectric layers 204 for limiting a discharge current and providing insulation between the scan electrode 202 and the sustain electrode 203. A protective layer 205 with a deposit of MgO is formed on an upper surface of the upper dielectric layer 204 to facilitate discharge conditions.

A plurality of stripe-type (or well-type) barrier ribs 212 are arranged in parallel on the rear substrate 211 of the rear panel 210 to form a plurality of discharge spaces (i.e., a plurality of discharge cells). The plurality of address electrodes 213 for performing an address discharge to generate vacuum ultraviolet rays are arranged in parallel to the barrier ribs 212.

An upper surface of the rear panel 210 is coated with Red (R), green (G) and blue (B) phosphors 214 for emitting visible light for an image display when the address discharge is performed. A lower dielectric layer 215 is formed between the address electrodes 213 and the phosphors 214 to protect the address electrodes 213.

only an example of the plasma display panel applicable to the embodiments was illustrated in FIG. 2. Accordingly, the plasma display panel is not limited to the structure of the plasma display panel illustrated in FIG. 2.

For example, FIG. 2 has illustrated the scan electrode 202 and the sustain electrode 203 each including the transparent electrode and the bus electrode. However, at least one of the scan electrode 202 and the sustain electrode 203 may include either the bus electrode or the transparent electrode.

Further, FIG. 2 has illustrated and described the structure of the plasma display panel, in which the front panel 200 includes the scan electrode 202 and the sustain electrode 203 and the rear panel 210 includes the address electrode 213. However, the front panel 200 may include all the scan electrode 202, the sustain electrode 203, and the address electrode 213. At least one of the scan electrode 202, the sustain electrode 203, and the address electrode 213 may be formed on the barrier rib 212.

Considering the structure of the plasma display panel of FIG. 2, the plasma display panel applicable to the embodiments has only to include the scan electrode 202, the sustain electrode 203, and the address electrode 210. The plasma display panel may have various structures as long as the above-described structural characteristic is included.

The description of FIG. 2 is completed, and the description of FIG. 1 continues again.

The scan driver 102 supplies a set-down pulse of a negative polarity to the scan electrode Y of the plasma display panel 100 during a reset period. Further, the scan driver 102 supplies a scan pulse of a negative polarity to the scan electrode Y during an address period, and supplies a sustain pulse of a negative polarity to the scan electrode Y during a sustain period.

The sustain driver 103 supplies a sustain pulse of a negative polarity to the sustain electrode Z during the sustain period. The scan driver 102 and the sustain driver 103 alternately operate during the sustain period.

The data driver 101 supplies a data pulse to the address electrode X during the address period.

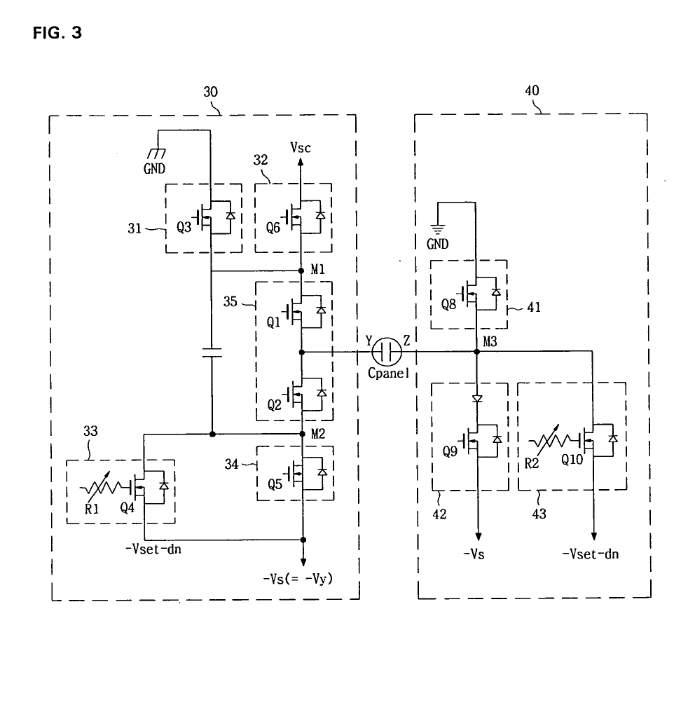

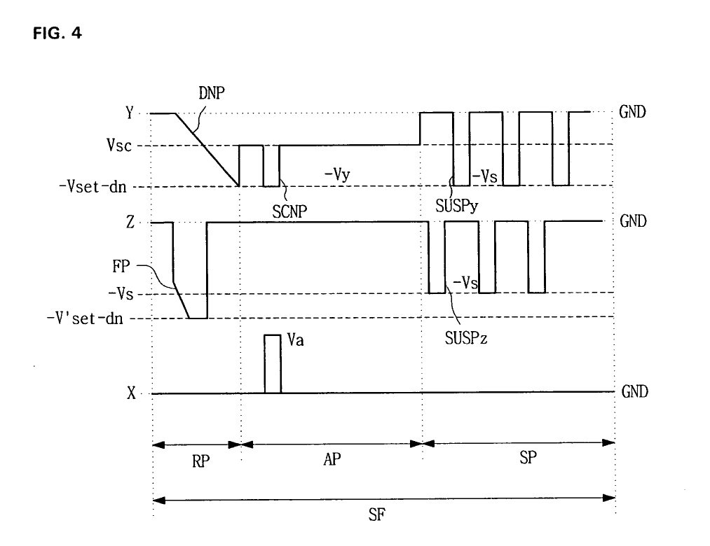

FIG. 3 illustrates a plasma display apparatus according to a first embodiment. FIG. 4 illustrates a driving waveform generated by the plasma display apparatus according to the first embodiment.

Referring to FIGS. 3 and 4, the plasma display apparatus according to the first embodiment includes a scan driver 30 and a sustain driver 40.

The scan driver 30 supplies a set-down pulse DNP, falling from a ground level voltage GND to a first negative set-down voltage (−Vset-dn), to a scan electrode Y of a plasma display panel Cpanel during a reset period RP. The scan driver 30 supplies a scan pulse SCNP having a negative scan reference voltage −Vsc and a negative scan voltage −Vy to the scan electrode Y during an address period AP.

The scan driver 30 supplies a sustain pulse SUSPy having the ground level voltage GND and a negative sustain voltage −Vs to the scan electrode Y during a sustain period SP.

The plasma display apparatus according to the first embodiment supplies the first negative set-down voltage (−Vset-dn), the negative scan voltage −Vy, and the negative sustain voltage −Vs using the same voltage source, for example, a first voltage source (−Vs).

Accordingly, since a circuit for supplying the voltages during the reset period and the address period and a circuit for supplying the voltage during the sustain period are driven through a single circuit, a configuration of a driving circuit is simplified. This will be described later.

The scan driver 30 includes a first ground level voltage supply controller 31, a scan reference voltage supply controller 32, a first set-down voltage supply controller 33, a scan/sustain voltage supply controller 34, and a scan integrated Circuit (IC) 35.

The first ground level voltage supply controller 31 is connected to a common terminal of the scan reference voltage supply controller 32 and the scan IC 35. The first ground level voltage supply controller 31 includes a third switch Q3. The third switch Q3 is turned on such that the ground level voltage GND is supplied to the scan electrode Y of the plasma display panel Cpanel during the sustain period SP.

The scan reference voltage supply controller 32 includes a sixth switch Q6, and is connected to a common terminal of the first ground level voltage supply controller 31 and the scan IC 35. The scan reference voltage supply controller 32 supplies the negative scan reference voltage −Vsc to the scan electrode Y during the address period AP.

The scan reference voltage supply controller 32 turns on a first switch Q1 of the scan IC 35 in response to a switching control signal received from a timing controller (not illustrated) such that the negative scan reference voltage −Vsc is supplied to the scan electrode Y.

The first set-down voltage supply controller 33 is connected in parallel to the scan/sustain voltage supply controller 34.

The first set-down voltage supply controller 33 supplies the set-down pulse DNP, falling from the ground level voltage GND to the first negative set-down voltage (−Vset-dn) with a predetermined slope, to the scan electrode Y during the reset period RP in response to a switching control signal received from the timing controller.

The first set-down voltage supply controller 33 includes a fourth switch Q4 connected between a common terminal of the scan/sustain voltage supply controller 34 and the scan IC 35 and the first voltage source (−Vs), and a first variable resistor R1 connected to a gate terminal of the fourth switch Q4.

The scan/sustain voltage supply controller 34 is connected in parallel to the first set-down voltage supply controller 33. The scan/sustain voltage supply controller 34 supplies the scan pulse SCNP having the negative scan voltage −Vy to the scan electrode Y during the address period AP.

The scan/sustain voltage supply controller 34 includes a fifth switch Q5 connected between a common terminal of the first set-down voltage supply controller 33 and the scan IC 35 and the first voltage source (−Vs).

The fifth switch Q5 is turned on in response to a switching control signal received from the timing controller such that the negative scan voltage −Vy received from the first voltage source (−Vs) is supplied to the scan electrode Y.

The scan/sustain voltage supply controller 34 supplies the negative sustain voltage −Vs to the scan electrode Y during the sustain period SP. The first ground level voltage supply controller 31 and the scan/sustain voltage supply controller 34 alternately operate during the sustain period SP.

The fifth switch Q5 is turned on in response to a switching control signal received from the timing controller such that the negative sustain voltage −Vs is supplied to the scan electrode Y.

The scan IC 35 includes the first switch Q1 and a second switch Q2 which are connected between a common terminal of the first ground level voltage supply controller 31 and the scan reference voltage supply controller 32 and a common terminal of the first set-down voltage supply controller 33 and the scan/sustain voltage supply controller 34 in a push-pull manner.

A common terminal of the first switch Q1 and the second switch Q2 is connected to the scan electrode Y.

The first switch Q1 is turned on in response to a switching control signal received from the timing controller such that the negative scan reference voltage −Vsc and the ground level voltage GND are supplied to the scan electrode Y. The second switch Q2 is turned on in response to a switching control signal received from the timing controller such that the first negative set-down voltage (−Vset-dn) and the negative scan voltage −Vy are supplied to the scan electrode Y.

The first negative set-down voltage (−Vset-dn), the negative scan voltage −Vy, and the negative sustain voltage −Vs are supplied using the same voltage source (i.e., the first voltage source). Therefore, these voltages −Vset-dn, −Vy and −Vs have an equal voltage level.

As above, since the plasma display apparatus according to the first embodiment supplies the voltages −Vset-dn, −Vy and −Vs using the first voltage source, the circuit configuration of the scan driver 30 is simplified such that a reduction in the cost of the plasma display apparatus is achieved.

The sustain driver 40 supplies a falling pulse FP, falling from a predetermined negative voltage to a second negative set-down voltage (−V′set-dn) with a predetermined slope, to the sustain electrode Z of the plasma display panel Cpanel during the reset period (RP).

The sustain driver 40 supplies the ground level voltage GND to the sustain electrode Z during the address period AP.

The sustain driver 40 supplies a negative sustain pulse SUSPz having the ground level voltage GND and the negative sustain voltage −Vs to the sustain electrode Z during the sustain period SP.

The sustain driver 40 includes a second ground level voltage supply controller 41, a sustain voltage supply controller 42, and a second set-down voltage supply controller 43. The second ground level voltage supply controller 41 supplies the ground level voltage GND, the sustain voltage supply controller 42 supplies the negative sustain voltage −Vs, and the second set-down voltage supply controller 43 supplies the second negative set-down voltage (−V′set dn) to the sustain electrode Z.

The second ground level voltage supply controller 41 is connected to the sustain electrode Z. The second ground level voltage supply controller 41 supplies the ground level voltage GND to the sustain electrode Z during the address period AP and during the sustain period SP. The second ground level voltage supply controller 41 and the sustain voltage supply controller 42 alternately operate during the sustain period SP.

The second ground level voltage supply controller 41 includes an eighth switch Q8 connected between a ground level voltage source (GND) and the sustain electrode Z.

The eighth switch Q8 is turned on in response to a switching control signal received from the timing controller such that the ground level voltage GND is supplied to the sustain electrode Z.

The eighth switch Q8 and a ninth switch Q9 of the sustain voltage supply controller 42 alternately operate during the sustain period SP. Accordingly, the ground level voltage GND and the negative sustain voltage −Vs are alternately supplied to the sustain electrode Z during the sustain period SP.

The sustain voltage supply controller 42 is connected to the sustain electrode Z such that the negative sustain voltage −Vs is supplied to the sustain electrode Z during the sustain period SP.

The sustain voltage supply controller 42 includes the ninth switch Q9 connected between a negative sustain voltage source (−Vs) and the sustain electrode Z.

The ninth switch Q9 is turned on in response to a switching control signal received from the timing controller such that the negative sustain voltage −Vs is supplied to the sustain electrode Z during the sustain period SP.

The second set-down voltage supply controller 43 is connected to the sustain electrode Z. The second set-down voltage supply controller 43 supplies the falling pulse FP, falling from the predetermined negative voltage to the second negative set-down voltage (−V′set-dn) with the predetermined slope, to the sustain electrode Z during the reset period RP.

The second set-down voltage supply controller 43 includes a tenth switch Q10 positioned between a second negative set-down voltage source (−V′set-dn) and the sustain electrode Z, and a second variable resistor R2 connected to a gate terminal of the tenth switch Q10.

The tenth switch Q10 is turned on in response to a switching control signal received from the timing controller such that the second negative set-down voltage (−V′set-dn) is supplied to the sustain electrode Z. In this case, the second variable resistor R2 controls a slope of the second negative set-down voltage (−V′set-dn) supplied from the second negative set-down voltage source (−V′set-dn).

The above-described switches Q1 to Q9 may use a field effect transistor (FET) with a built-in body diode. However, the switches Q1 to Q9 is not limited the FET.

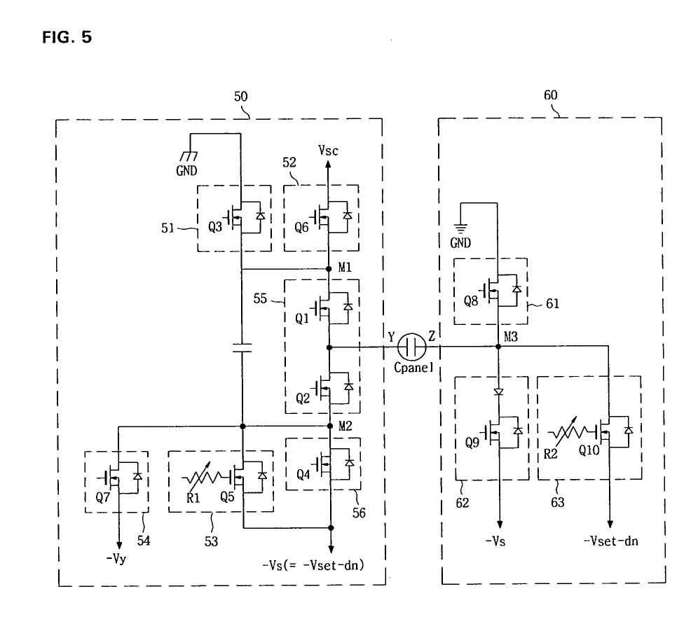

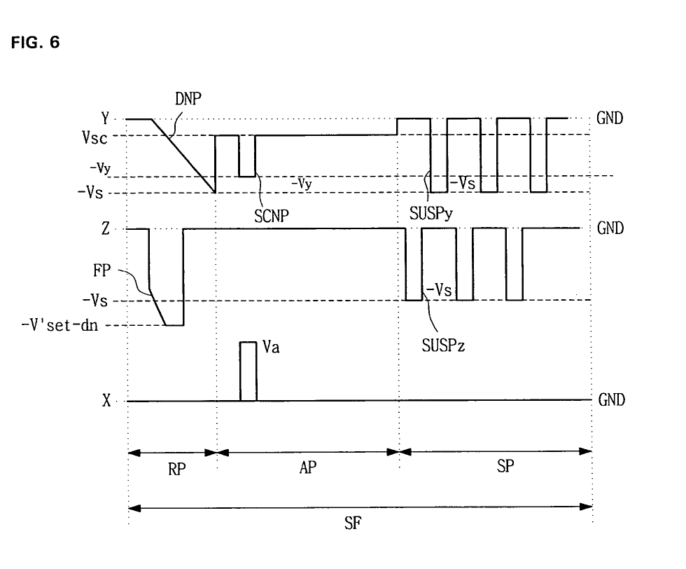

FIG. 5 illustrates a plasma display apparatus according to a second embodiment. FIG. 6 illustrates a driving waveform generated by the plasma display apparatus according to the second embodiment.

Referring to FIGS. 5 and 6, since a configuration and an operation of the plasma display apparatus according to the second embodiment are the same as those of the plasma display apparatus according to the first embodiment except the first set-down voltage supply controller 33 and the scan/sustain voltage supply controller 34 of the first embodiment, a description thereof is omitted.

A first set-down voltage supply controller 53 and a sustain voltage supply controller 56 supply a first negative set-down voltage (−Vset-dn) and a negative sustain voltage −Vs using the same voltage source, i.e., a first voltage source (−Vs) to a scan electrode Y of a plasma display panel Cpanel. A scan/sustain voltage supply controller 54 supplies a negative scan voltage −Vy using a second voltage source (−Vy) to the scan electrode Y. The second voltage source (−Vy) has a voltage level different from a voltage level of the first voltage source (−Vs).

Accordingly, a level of the negative scan voltage −Vy may be different from levels of the first negative set-down voltage (−Vset-dn) and the negative sustain voltage −Vs depending on a characteristic of the plasma display apparatus.

A voltage level of the first voltage source (−Vs) may be less than a voltage level of the second voltage source (−Vy).

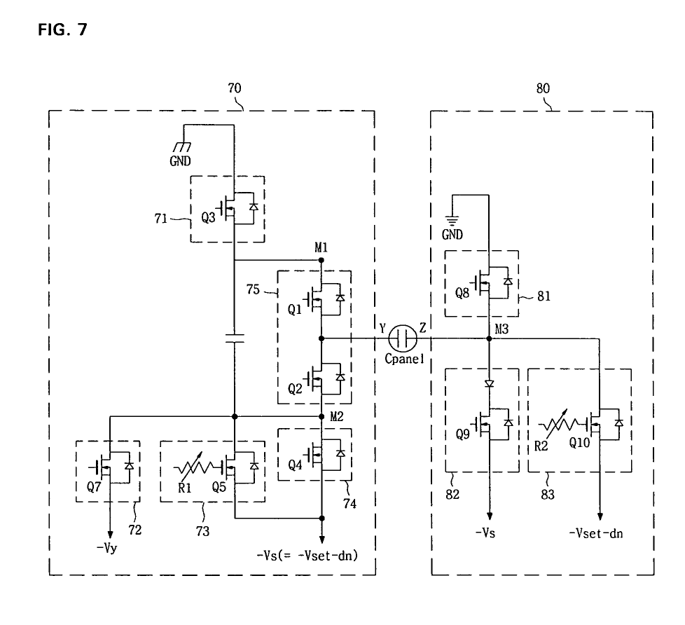

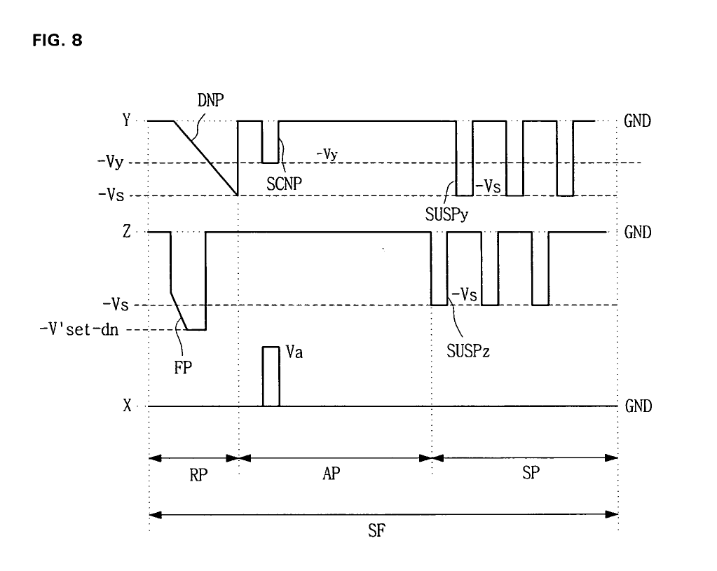

FIG. 7 illustrates a plasma display apparatus according to a third embodiment. FIG. 8 illustrates a driving waveform generated by the plasma display apparatus according to the third embodiment.

Referring to FIGS. 7 and 8, since a configuration and an operation of the plasma display apparatus according to the third embodiment are the same as those of the plasma display apparatus according to the second embodiment except the first ground level voltage supply controller 51 and the scan reference voltage supply controller 52 of the second embodiment, a description thereof is omitted.

The plasma display apparatus according to the third embodiment does not include a scan reference voltage source (Vsc) for supplying a scan reference voltage Vsc. Therefore, the plasma display apparatus according to the third embodiment does not include a scan reference voltage supply controller corresponding to a reference numeral 52 in FIG. 5.

A first ground level voltage supply controller 71 supplies a ground level voltage GND to a scan electrode Y of a plasma display panel Cpanel during a reset period RP and a sustain period SP, and supplies a scan pulse SP having the ground level voltage GND and a negative scan voltage −Vy to the scan electrode Y during an address period AP.

As above, the plasma display apparatus according to the third embodiment supplies the scan reference voltage Vsc using a ground level voltage source (GND) during the address period AP. A circuit configuration of the plasma display apparatus is simpler.

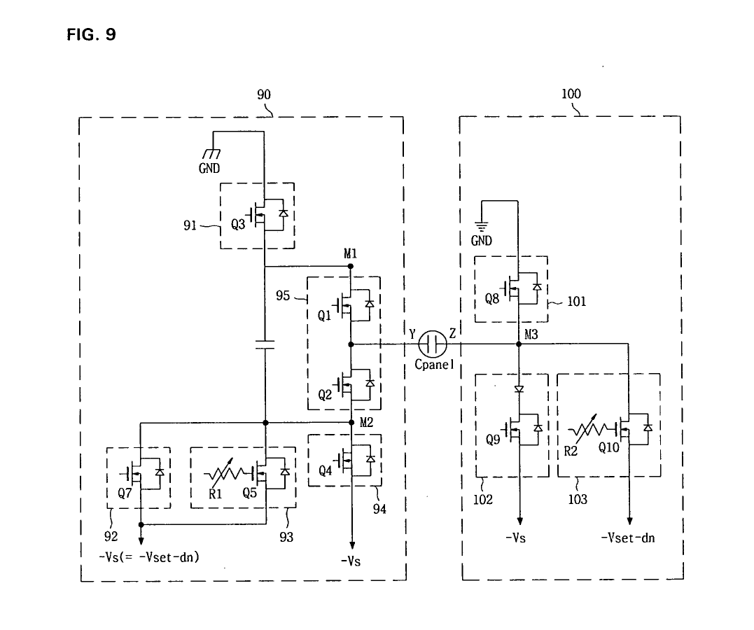

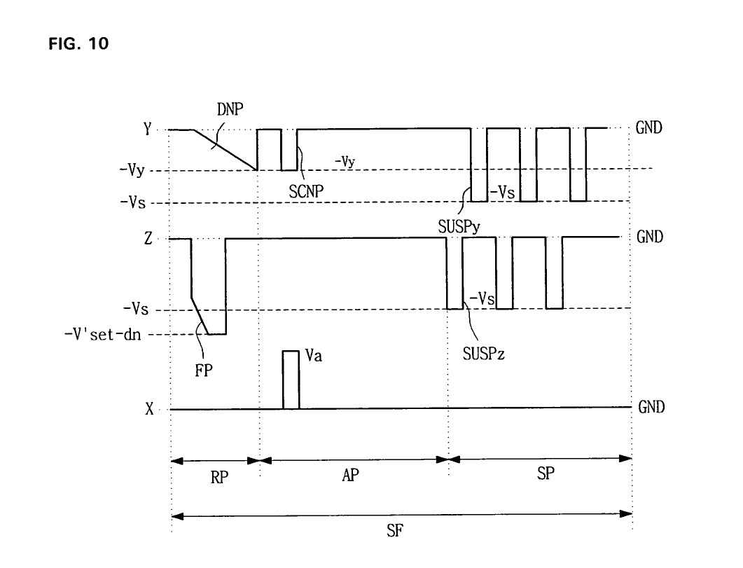

FIG. 9 illustrates a plasma display apparatus according to a fourth embodiment. FIG. 10 illustrates a driving waveform generated by the plasma display apparatus according to the fourth embodiment.

Referring to FIGS. 9 and 10, since a configuration and an operation of the plasma display apparatus according to the fourth embodiment are the same as those of the plasma display apparatus according to the third embodiment except the scan voltage supply controller 72, the first set-down voltage supply controller 73, and the sustain voltage supply controller 74 of the third embodiment, a description thereof is omitted.

A scan voltage supply controller 92 and a first set-down voltage supply controller 93 supply a negative scan voltage −Vy and a first negative set-down voltage (−Vset-dn) using the same voltage source, i.e., a first voltage source (−Vy) to a scan electrode Y of a plasma display panel Cpanel. A sustain voltage supply controller 94 supplies a negative sustain voltage −Vs using a second voltage source (−Vs) to the scan electrode Y. The second voltage source (−Vs) has a voltage level different from a voltage level of the first voltage source (−Vy).

Accordingly, a level of the negative sustain voltage −Vs may be different from levels of the first negative set-down voltage (−Vset-dn) and the negative scan voltage −Vy depending on a characteristic of the plasma display apparatus.

A voltage level of the first voltage source (−Vy) may be more than a voltage level of the second voltage source (−Vs).

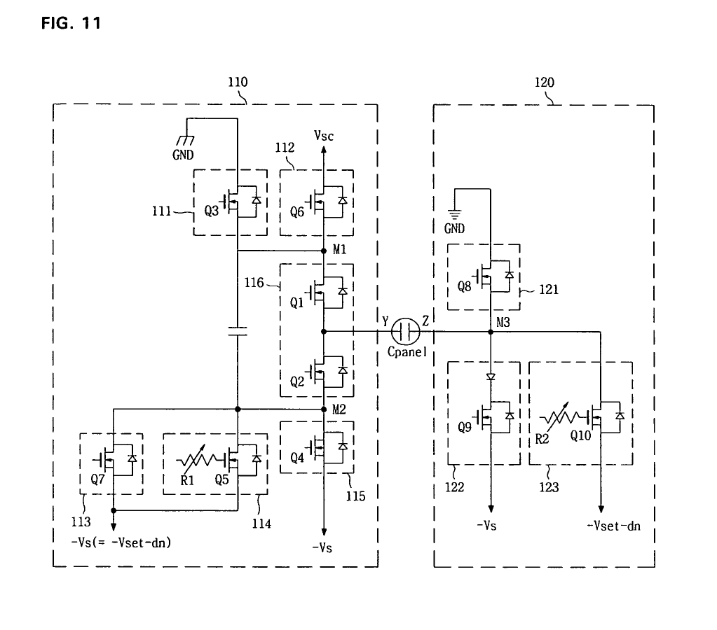

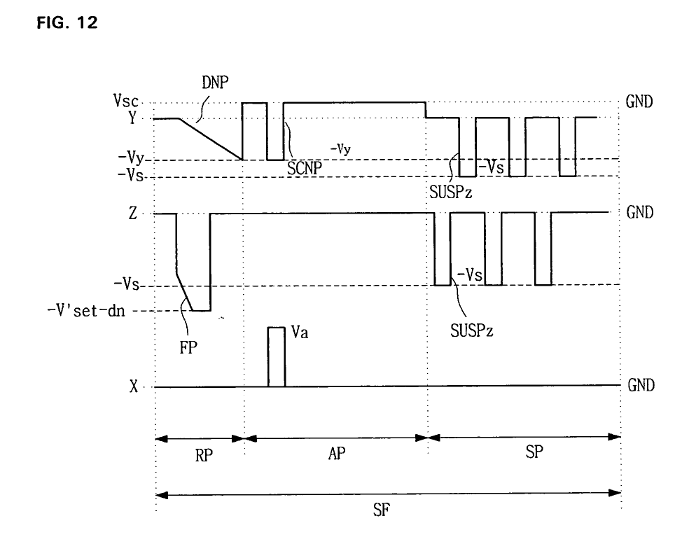

FIG. 11 illustrates a plasma display apparatus according to a fifth embodiment. FIG. 12 illustrates a driving waveform generated by the plasma display apparatus according to the fifth embodiment.

Referring to FIGS. 11 and 12, since a configuration and an operation of the plasma display apparatus according to the fifth embodiment are the same as those of the plasma display apparatus according to the second embodiment except the first set-down voltage supply controller 53, the scan voltage supply controller 54, and the sustain voltage supply controller 56 of the second embodiment, a description thereof is omitted.

A scan voltage supply controller 113 and a first set-down voltage supply controller 114 supply a negative scan voltage −Vy and a first negative set-down voltage (−Vset-dn) using the same voltage source, i.e., a first voltage source (−Vy) to a scan electrode Y of a plasma display panel Cpanel. A sustain voltage supply controller 115 supplies a negative sustain voltage −Vs using a second voltage source (−Vs) to the scan electrode Y. The second voltage source (−Vs) has a voltage level different from a voltage level of the first voltage source (−Vy).

Accordingly, a level of the negative sustain voltage −Vs may be different from levels of the first negative set-down voltage (−Vset-dn) and the negative scan voltage −Vy depending on a characteristic of the plasma display apparatus.

A voltage level of the first voltage source (−Vy) may be more than a voltage level of the second voltage source (−Vs).

As described above, the plasma display apparatus according to the embodiments supplies the set-down voltage, the scan voltage, and the sustain voltage using the negative voltage and the negative polarity pulse. Therefore, it is not necessary to use pass switches required in the related art plasma display apparatus, that simultaneously uses both a positive voltage and a negative voltage. Further, the plasma display apparatus according to the embodiments can be driven at a low voltage.

Since the plurality of voltages are supplied to the plasma display panel using the same voltage source, the circuit configuration of the plasma display apparatus according to the embodiments is simple such that a reduction in the cost is achieved.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel including a scan electrode and a sustain electrode; and
a scan driver that supplies a first set-down voltage of a set-down pulse during a reset period, a scan voltage of a scan pulse during an address period, and a negative sustain voltage of a sustain pulse of a negative polarity during a sustain period to the scan electrode,
wherein the first set-down voltage, the scan voltage, and the negative sustain voltage are supplied using a first voltage source.

2. The plasma display apparatus of claim 1, wherein a voltage level of the first voltage source is equal to the negative sustain voltage.

3. The plasma display apparatus of claim 2, wherein the scan driver includes
a scan/sustain voltage supply controller, connected to the first voltage source, controlling the supplying of the scan voltage and the negative sustain voltage to the scan electrode, and
a first set-down voltage supply controller, connected in parallel to the scan/sustain voltage supply controller, controlling the supplying of the first set-down voltage to the scan electrode.

4. The plasma display apparatus of claim 3, wherein the scan driver includes
a scan reference voltage supply controller controlling the supplying of a scan reference voltage to the scan electrode during the address period, and
a first ground level voltage supply controller controlling the supplying of a ground level voltage of the sustain pulse to the scan electrode during the sustain period.

5. The plasma display apparatus of claim 4, wherein the scan reference voltage is equal to a negative voltage level.

6. The plasma display apparatus of claim 1, further comprising a sustain driver that supplies a second set-down voltage during the reset period, and a sustain pulse having a ground level voltage and the negative sustain voltage during the sustain period to the sustain electrode.

7. A plasma display apparatus comprising:
a plasma display panel including a scan electrode and a sustain electrode; and
a scan driver that supplies a first set-down voltage of a set-down pulse during a reset period and a negative sustain voltage of a sustain pulse of a negative polarity during a sustain period to the scan electrode using a first voltage source, and supplies a scan voltage of a scan pulse to the scan electrode during an address period using a second voltage source.

8. The plasma display apparatus of claim 7, wherein a voltage level of the first voltage source is equal to the negative sustain voltage, and the voltage level of the first voltage source is lower than a voltage level of the second voltage source.

9. The plasma display apparatus of claim 8, wherein the scan driver includes
a sustain voltage supply controller, connected to the first voltage source, controlling the supplying of the negative sustain voltage to the scan electrode,
a first set-down voltage supply controller, connected in parallel to the sustain voltage supply controller, controlling the supplying of the first set-down voltage to the scan electrode, and
a scan voltage supply controller, connected to the second voltage source, controlling the supplying of the scan voltage to the scan electrode.

10. The plasma display apparatus of claim 9, wherein the scan driver includes
a scan reference voltage supply controller controlling the supplying of a scan reference voltage to the scan electrode during the address period, and
a first ground level voltage supply controller controlling the supplying of a ground level voltage of the sustain pulse to the scan electrode during the sustain period.

11. The plasma display apparatus of claim 10, wherein the scan reference voltage is equal to a negative voltage level.

12. The plasma display apparatus of claim 9, wherein the scan driver includes a first ground level voltage supply controller that controls the supplying of a ground level voltage of the sustain pulse to the scan electrode during the sustain period and the supplying of a scan reference voltage to the scan electrode during the address period, and
the ground level voltage of the sustain pulse and the scan reference voltage are supplied using a ground level voltage source.

13. The plasma display apparatus of claim 7, further comprising a sustain driver that supplies a second set-down voltage during the reset period, and a sustain pulse having a ground level voltage and the negative sustain voltage during the sustain period to the sustain electrode.

14. A plasma display apparatus comprising:
a plasma display panel including a scan electrode and a sustain electrode;
a scan driver that supplies a first set-down voltage of a set-down pulse during a reset period and a scan voltage of a scan pulse during an address period to the scan electrode using a first voltage source, and supplies a negative sustain voltage of a sustain pulse of a negative polarity to the scan electrode during a sustain period using a second voltage source; and
a sustain driver that supplies a second set-down voltage during the reset period, and a sustain pulse having a ground level voltage and the negative sustain voltage during the sustain period to the sustain electrode.

15. The plasma display apparatus of claim 14, wherein a voltage level of the second voltage source is equal to the negative sustain voltage, and the voltage level of the second voltage source is lower than a voltage level of the first voltage source.

16. The plasma display apparatus of claim 14, wherein the scan driver includes
a scan voltage supply controller, connected to the first voltage source, controlling the supplying of the scan voltage to the scan electrode,
a first set-down voltage supply controller, connected in parallel to the scan voltage supply controller, controlling the supplying of the first set-down voltage to the scan electrode, and
a sustain voltage supply controller, connected to the second voltage source, controlling the supplying of the negative sustain voltage to the scan electrode.

17. The plasma display apparatus of claim 16, wherein the scan driver includes
a scan reference voltage supply controller controlling the supplying of a scan reference voltage to the scan electrode during the address period, and
a first ground level voltage supply controller controlling the supplying of a ground level voltage of the sustain pulse to the scan electrode during the sustain period.

18. The plasma display apparatus of claim 17, wherein the scan reference voltage is equal to a negative voltage level.

19. The plasma display apparatus of claim 16, wherein the scan driver includes a first ground level voltage supply controller that controls the supplying of a ground level voltage of the sustain pulse to the scan electrode during the sustain period and the supplying of a scan reference voltage to the scan electrode during the address period, and
the ground level voltage of the sustain pulse and the scan reference voltage are supplied using a ground level voltage source.
